(19) United States
(12) Patent Application Publication
(10) Pub. No.: US 2005/0037715 A1
(43) Pub. Date: Feb. 17, 2005

(54) Apparatus for reversible converting standard telephone into a cordless telephone

(76) Inventor: Terry Zulkowski, Needville, TX (US)

Correspondence Address: Intellectual Property Services, 2502 Lively Lane, Sugar Land, TX, 77479-1746, US

(21) Appl. No.: 10/639,262

(22) Filed: Aug. 12, 2003

(51) Int. Cl. H04B 1/40

(52) U.S. Cl. 455/74.1; 455/74

(57) ABSTRACT

A pair of mutually communicative signal converters useful for converting a standard telephone into a cordless phone is provided, wherein each of said pair of signal converters comprise an amplifier, a transmitter and a receiver. The converters broadcast either analog or digital FM radio signals, and remove the need for the handset and the base of a standard phone to be connected by a wire cord. The converters broadcast signals in frequency ranges of about 27 MHz, 43-50 MHz, 900-928 MHz, 2.4 GHz, 5.8 GHz, and greater than about 5.8 GHz. When broadcasting digital signals, the converters employ digital spread spectrum technology to divide a total signal package into smaller, discrete packets, which are then broadcast over a plurality of frequency ranges in order to provide greater security for the user.

### FIELD OF THE INVENTION

The present invention relates generally to the means by which the base and the handset of a standard telephone mutually communicate, and more particularly to an apparatus that can quickly and reversibly convert a standard telephone having a base and a handset connected by a detachable wire into a cordless telephone.

### BACKGROUND OF THE INVENTION

Standardized telephone technology is well known, and has remained remarkably similar over the past century. In its most basic form (see, for example, Prior Art FIG. 1), a standard telephone comprises a switch 11, a speaker 12, a microphone 13, and an input/output connection 14 for connecting the phone to a local telephone network.

The switch 11, usually called a hook switch, is used to connect and disconnect the input/output connection 14 from the network. In most standard phones, the hook switch 11 completes a system circuit whenever a user removes the handset from a cradle disposed on the telephone base (not shown). The speaker 12, through which a user hears the voice signal generated by a second user connected along the network, is generally a simple and inexpensive 8-ohm speaker of some type, though speakers of various other ohmic resistances are also employed. Finally, the microphone 13 is used to generate a user voice signal that is subsequently transmitted to the network for relay to other users.

Originally, telephone microphones were simple carbon granule packages compressed between two or more thin metal plates. In this configuration, sound waves from the user's voice would compress and decompress the granules, thereby changing the resistance of the granules and modulating the current flowing through the microphone.

The primary difficulty with the basic phone system described above is that when a user speaks into the microphone, his or her voice will be heard not only by the other party, but also through the user's own speaker. Thus, modern phones also contain a duplex coil 15 (or a functional equivalent), disposed in electrical communication with the handset by means of a detachable cord or wire, which blocks the sound of a user's voice from reaching the phone's own speaker. A basic telephone also includes a ringer 16 (for example, a mechanical bell or the like), which rings so as to notify the user when an incoming call has been received; and a rotary dial or touch-tone keypad 17, which operates in association with an integrally disposed frequency generator so as to allow the user to call out to other parties connected along the network.

In most modern phones, an electronic microphone has replaced the aforementioned carbon granule microphone, and an amplifier and appropriate circuitry are employed to facilitate microphone operation. Also, an auxiliary speaker and a signal-emitting circuit responsive to incoming calls are often employed in place of the ringer in order to generate a more pleasant ringing tone when an incoming call is received.

Cordless telephones have many of the same features as standard telephones, though they are combined with radio transmitter/receiver technology in order to facilitate electronic signal communication between the telephone base and the handset without the need for a wire or cord being disposed therebetween.

With a cordless telephone, the base is usually attached by means of a phone jack or the like to an input/output connection that connects the device to a local telephone network. In terms of system operation, a cordless telephone's calling and receiving functions are carried out in a manner fundamentally similar to the standard telephones discussed above; a principal difference, however, is that when the base of a cordless set receives an incoming call from a network through its input/output connection, the incoming electrical signal is converted by the base into an FM radio signal, and then broadcast via an antenna in such a fashion that the radio signal can be received by an appropriate receiver disposed in the handset.

The handset receives the radio signal from the base, converts it back into an electrical signal, and then sends the converted signal to the handset's speaker, where it is converted into a compression wave that creates the sound ultimately heard by the user. When the user speaks, the process is essentially reversed, viz., the handset converts the speaker's voice into an FM radio signal and then transmits the converted signal back to the base; the base then receives the radio signal, converts it back into an electrical signal, and sends the converted signal back through the phone line to the other party.

The base and handset typically operate on a frequency pair called a duplex frequency that allows the user to both talk and listen at the same time. Early cordless phones facilitated communication between the handset and the base by utilizing a radio signal having a frequency of around 27 MHz. This early technology was plagued by application problems, however, including limited range, signal interference, poor sound quality, and a general lack of security (since signals were often inadvertently picked up by other cordless phone users in the area).

By the mid-1980s, the Federal Communications Commission (FCC) opened up the 43-50 MHz frequency range for cordless phones, which reduced signal interference and the amount of power necessary to operate the phone, but the devices still suffered from a limited range and poor sound quality. For example, phones operating at such frequencies only have effective ranges of about 1,000 feet or so, and sound quality is easily distorted by signal interference caused by neighboring structures and/or household appliances. The 43-50 MHz phone signals could also be easily picked up on radio scanners and nearby baby monitors.

As cordless telephone signal transmissions became increasingly concentrated, especially in high population density locations, the FCC eventually opened up frequency ranges of around 900-928 MHz for cordless communications. These higher frequency communications allowed cordless phone users to both send and receive clearer signals, broadcast over longer distances, and to subdivide signal frequencies into a plurality of narrower signal channels. However, cordless phones were still quite expensive, and security remained a problem, as other cordless users and short wave radio scanners could easily eavesdrop on cordless communications. Even today, analog signal transmitters broadcasting at around 900 MHz are common in cordless telephones, especially in inexpensive models, but such devices continue to be noisy, prone to interference, and of poor quality with respect to sound clarity.

In the early 1990s, digital cordless phones in the 900 MHz frequency range were introduced. Digital signals allowed the phones to be more secure, and signal overlap and short wave eavesdropping were greatly decreased. Around 1995, digital spread spectrum (DSS) was introduced for cordless phones, which enabled the digital signal to be broken up into discrete packets and then spread over several frequencies between the handset and the base, thereby making it extremely difficult to eavesdrop on the users' conversations.

By the late 1990s, the FCC had opened up the 2.4 and 5.8 GHz ranges for cordless phone use, and still higher frequencies will likely be made available in the future. These higher frequencies have greatly increased the distance over which a cordless phone can operate, and have raised the communication signals beyond the frequency range of most radio scanners, thereby increasing security further still.

Referring now to Prior Art FIG. 2, the essential components and electrical connections required in the base of a cordless telephone are depicted in a block diagram. As seen, the system includes a phone-line interface 21, various radio components 22, an antenna 23, various user inputs and outputs 24, power components 25, and a battery charger 26.

The phone-line interface 21 is responsible for accomplishing two primary tasks. First, it sends an electronic signal to the ringer (if the ringer is disposed within the base), or to the radio components of the handset (if the ringer is disposed therein), so as to notify the user when there is an incoming call. Second, it sends and receives a variety of slightly different electrical signals to and from the radio components of the base in response to the voice patterns of the user and the party engaged in the other end of the conversation. These slight differences in electrical signals are what enable a phone's user to ultimately communicate with the other party.

The radio components 22 receive electrical signals from the phone-line interface 21, and also from various user controls (for example, a keypad or buttons, etc.). The radio components 22 also convert incoming electrical signals to radio waves, and then broadcast the radio waves via an antenna 23. The radio components 22 typically use quartz crystals to set the radio frequencies for sending and receiving. There are generally two quartz crystals, one for sending signals and one for receiving signals. Since the base and the handset operate on a frequency pair (or duplex), a user can both talk and listen at the same time. The radio components typically include an audio amplifier for increasing the strength of incoming electrical signals, and for decreasing the amount of power required to operate the device.

The power components 25 usually comprise a direct current (DC) power cube transformer (not shown), which supplies the low voltage required by the electrical components disposed on the phone's main circuit board (also not shown). The power components on the circuit board also work in electrical cooperation with the DC power cube to supply current to a battery charger 26, which re-charges the battery of the handset when the handset is replaced in the base's cradle in such a fashion that a pair of metal contacts reciprocally disposed on the handset and base are mutually aligned.

In addition to the basic components described above, bases for cordless phones also often comprise an audio amplifier, used to drive speakers for speaker phone features; a keypad 24 for dialing; a liquid crystal display (LCD) used for caller ID functions; light-emitting diodes (LED) for power/charging indicator lights; and a solid state memory chip for answering machine and/or call-back features (not shown).

Referring now to Prior Art FIG. 3, a unit block diagram of a typical handset as would be used in association with a cordless telephone system is provided, wherein said handset comprises a speaker 31, a microphone 32, a keypad 33, a ringer 34, radio components 35, and a rechargeable battery 36. Thus, the typical cordless handset includes essentially all of the equipment included in a basic telephone (e.g., a speaker, microphone and dialing keypad) as described above, plus the equipment of an FM radio transmitter/receiver.

The speaker 31 receives electrical signals from the audio amplifier in the radio components 35, and then converts them into the sounds actually heard by the user. Inside the cover of the speaker, there is generally disposed a large round permanent magnet with a hole in the middle and a deep groove surrounding the hole. Within this deep groove is typically a coil of fine copper wire attached to a thin plastic membrane. The plastic membrane usually covers the entire magnet and coil. The sequence necessary for a user to ultimately hear sound from the speaker includes at least the following steps:
1. Electrical signals are received by the speaker from the handset's radio components;
2. The electrical signals travel within the coil of copper wire;
3. The electrical signals induce a magnetic current in the coil of wire, thereby establishing an electromagnet;
4. The electromagnetic coil moves in and out of the groove within the permanent magnet;
5. The coil moves the attached plastic membrane in and out at the same frequencies as the changes in electric currents; and
6. The movements of the membrane move surrounding air at the same frequencies, thereby creating compression-type sound waves that can be heard and interpreted by the human ear.

Microphone 32 converts sound waves from a user's voice into electrical signals that are sent to an audio amplifier in the handset's radio components 35. The microphone 32 is essentially a speaker that works in reverse; for example, when sound waves from the user's voice move the membrane, the coil of copper wiring within the magnet creates small amounts of electric current that are transmitted back to the handset's radio components 35.

The keypad 33 allows the user to dial a number so as to establish communication with another user on the network. The keypad 33 transfers pressure applied by the user to an appropriate key into an electrical signal, which is then sent to the handset's radio components 35. Below the keypad is typically a circuit board with a conductive material disposed beneath each button. In application, the keypad 33 functions as a remote control; for example, when a user presses a button, the button establishes contact with the conductive material, thereby altering its electrical conductance. The conductor then emits a signal to the handset's radio components 35 that indicates the user has selected a particular number.

When the handset's radio components 35 receive a ringer signal from the base, an electrical signal is sent to the handset's ringer 34. The ringer 34 converts the electrical signals into sound in a manner much like the speaker as described above. A sound is then emitted by the ringer 34, which notifies the user of an incoming call. In some phones, the speaker 31 is used to make the ringer sound; in such configurations, there is no need for a separate ringer 34.

In application, the functions of the handset's radio components 35 are quite similar to those of the base; for example, electrical signals from the microphone are converted into FM radio signals and then broadcast at about the same frequency as the receiving crystal of the base unit. The radio components 35 also receive radio signals at about the same frequency as the broadcasting crystal disposed in the base, convert the radio signals back into electrical signals, and then send the electrical signals on to the speaker 31 and/or ringer 34. Again, since the base and the handset operate on a duplex frequency, a user can both talk and listen at the same time.

Most handsets also have one or more light-emitting diodes (LED) that serve as indicators for various functions, for example, when the phone has an open line or when the battery is running low. Some handsets also have a liquid crystal display (LCD) that can display numbers for caller ID features. The LCD may also be reflective or backlit so that a user can still read displayed data even when the surrounding light is low.

The handset's battery (not shown) supplies the power for all of the electrical components in the handset. All common cordless handsets have a rechargeable battery of some type (for example, a battery comprising nickel-cadmium, nickel-metal hydride or lithium). On some models, when a battery runs low, an indicator light on the handset lights up or flashes. With other phones, a repeated “beeping” sound is used to indicate a low battery. In this manner, the user is notified to replace the handset into the cradle of the base for recharging by battery charger 36.

In more modern telephones, many of the electronic circuits that were once achieved with separate transistors, resistors and capacitors have been replaced with integrated circuitry. This advancement allows the handset to be made either smaller in size while maintaining the same number of functions, or made the same size with a greater number of functions.

To summarize the above discussion, a modern cordless phone is basically a combination of a standard telephone and an FM radio transmitter/receiver. To date, however, there has never been a means by which a user can quickly and reversibly convert a standard phone having a handset and a base connected by a wire cord (see Prior Art FIG. 4) into a cordless phone, so that the advantages of cordless phone technology can be realized by users of conventional, corded phone units.

### SUMMARY OF THE INVENTION

A pair of mutually communicative signal converters useful for converting a standard telephone into a cordless phone is provided, wherein each of said pair of signal converters comprise one or more transmitters, one or more receivers, one or more quartz crystals, one or more amplifiers, a means for converting an electrical signal into an FM radio signal, and a means for converting an FM radio signal into an electrical signal. The converters broadcast and receive FM radio signals in duplex frequency ranges of about 27 MHz, 43-50 MHz, 900-928 MHz, 2.4 GHz, 5.8 GHz, and greater than about 5.8 GHz, and remove the need for a standard telephone handset to be connected to the telephone base by means of a wire or cord.

### BRIEF DESCRIPTION OF THE DRAWINGS

Prior Art FIG. 1 is a schematic drawing showing the basic components of a standard telephone, wherein a handset is connected to the base by a wire.

Prior Art FIG. 2 is a unit block diagram showing the typical components of the base of a cordless telephone.

Prior Art FIG. 3 is a unit block diagram showing the typical components of the handset of a cordless telephone.

Prior FIG. 4 is a depiction of a detachable wire cord typically employed to connect a handset to the base of a standard telephone.

FIGS. 5A and 5B show an apparatus for replacing a detachable wire cord disposed between the handset and the base of a standard telephone with a pair of signal converters according to one embodiment of the present invention.

### DETAILED DESCRIPTION OF THE INVENTION

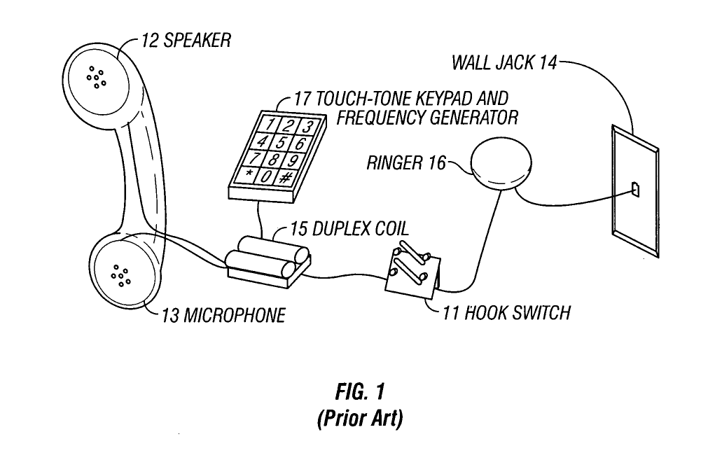

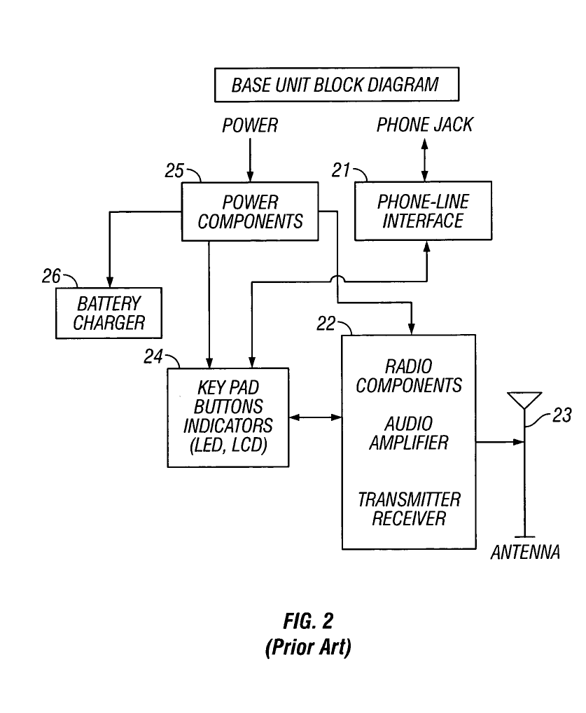

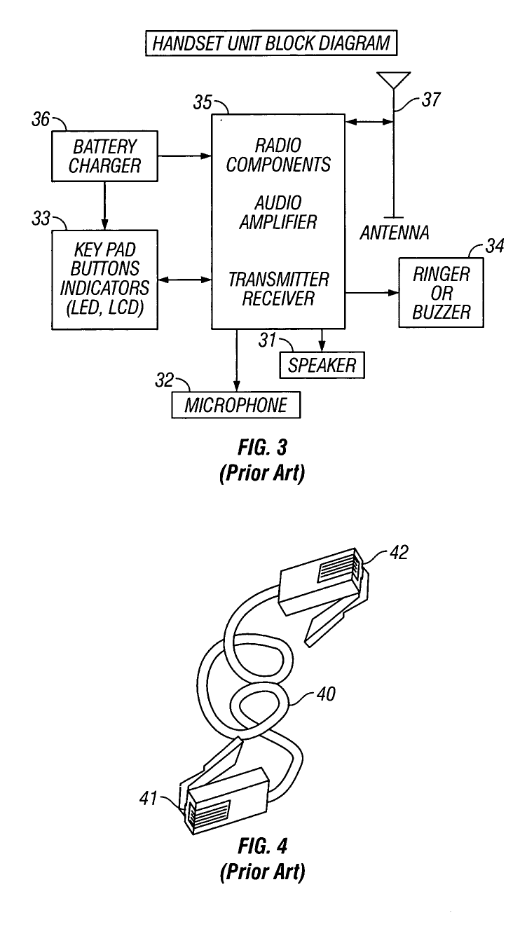

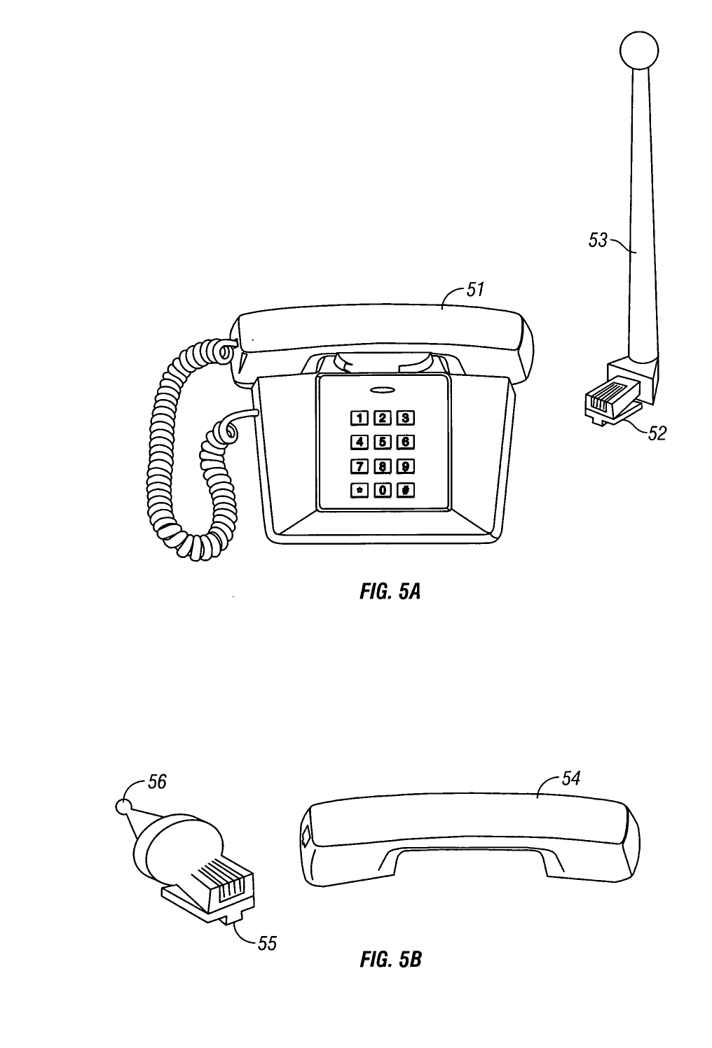

Referring now to FIGS. 5A and 5B, there is depicted a specific, though non-limiting, embodiment of the present invention comprising a pair of mutually communicative signal converters 52 and 55 useful for converting a standard telephone (i.e., a phone having a handset connected to a base by means of a detachable wire cord) into a cordless phone.

As seen in FIG. 5A, a standard telephone base 51 is fitted with a first signal converter 52 by means of a jack plugged into a port disposed in the base. The base port is usually employed to receive a first jack connected to a wire cord (see, for example, first jack 41 of Prior Art FIG. 4), though the need for a wire cord is eliminated when the base is fitted with a converter according to the present invention.

First converter 52 contains a variety of radio components, which are basically the same radio components as would be disposed in the base if the phone were a cordless unit instead of a standard unit. For example, the radio components of first converter 52 comprise a transmitter, a receiver, one or more quartz crystals, an amplifier, a means for converting electrical signals into either an analog or digital radio signal, and a means for converting either an analog or digital radio signal into an electrical signal. Converter 52 also has an antenna 53 formed structurally integral therewith, or alternatively, an antenna 53 detachably affixed by means of a fastener such as a screw or a nut and bolt assembly.

As seen in FIG. 5B, a standard telephone handset 54 is fitted with a second signal converter 55 by means of a jack plugged into a port disposed in the handset. The handset port is usually employed to receive a second jack connected to a wire cord (see, for example, second jack 42 of Prior Art FIG. 4), though the need for a wire cord is eliminated when the handset is fitted with a converter according to the present invention.

Second converter 55 also contains a variety of radio components (not individually shown), which are basically the same radio components as would be disposed in the handset if the phone were a cordless unit instead of a standard unit. For example, the radio components of second converter 55 comprise a transmitter, a receiver, one or more quartz crystals, an amplifier, a means for converting electrical signals into either an analog or digital radio signal, and a means for converting either an analog or digital radio signal into an electrical signal.

As modified by the first and second converters discussed above, the standard telephone set thereafter functions much the same as a cordless phone set. For example, in order to hear the voice of another party when a call has been received from a network through its input/output connection, the incoming electrical signal is forwarded by a phone-line interface contained within the base to first converter 52, which is plugged into a base port by means of a removable jack. The converter's radio components then convert the incoming electrical signals into an FM radio signal. In certain embodiments, the converted radio signal is amplified by the converter's amplifier, and then broadcast by a transmitter via an antenna in such a fashion that the signal is received by a receiver disposed in second converter 55. The signal received by second converter 55 is then converted back into an electrical signal and then passed on to a speaker disposed in the handset so that a voice signal is ultimately heard by the user.

When a user speaks into the handset, the process is basically reversed. For example, the handset's microphone converts the user's voice signal into electrical signals, said electrical signals then being passed on to second converter 55, which is disposed in a handset port by means of a removable jack. In certain embodiments, the radio components of second converter 55 convert the electrical signals into an FM radio signal, amplify the radio signal, and then transmit the radio signal back toward the base in such a fashion that the signal is received by a receiver disposed in first converter 52. The signal received by first converter 52 is converted by the device's radio components back into an electrical signal, and then passed on by the phone-line interface to a network for subsequent transmission to the other party.

Regardless of whether the user is sending or receiving signals, first converter 52 and second converter 55 operate over a duplex frequency that permits the user to both speak and listen at the same time. Frequency ranges for the transmissions presently reside in frequency domains of about 27 MHz, about 43-50 MHz, about 900-928 MHz, about 2.4 GHz, and about 5.8 GHz. In instances where digital signals are used, digital signal packages are broken up into smaller, discrete packets using digital spread spectrum (DSS) technology, and the discrete signal packets are then broadcast over a plurality of frequency ranges in order to provide greater security from eavesdropping for the user.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof.

1. An apparatus for reversibly converting a standard telephone into a cordless telephone, said apparatus comprising:
a first signal converter disposed in a standard telephone base port by means of a jack; and
a second signal converter disposed in a standard telephone handset port by means of a jack.

2. The apparatus of claim 1, wherein each of said first signal converter and said second signal converter further comprise a plurality of radio components.

3. The apparatus of claim 2, wherein said plurality of radio components further comprises one or more quartz crystals.

4. The apparatus of claim 2, wherein said plurality of radio components further comprises one or more transmitters.

5. The apparatus of claim 2, wherein said plurality of radio components further comprises one or more receivers.

6. The apparatus of claim 2, wherein said plurality of radio components further comprises one or more amplifiers.

7. The apparatus claim 2, wherein said plurality of radio components further comprises a means for converting an electrical signal into an analog radio signal.

8. The apparatus claim 2, wherein said plurality of radio components further comprises a means for converting an electrical signal into a digital radio signal.

9. The apparatus claim 2, wherein said plurality of radio components further comprises a means for converting an analog radio signal into an electrical signal.

10. The apparatus claim 2, wherein said plurality of radio components further comprises a means for converting a digital radio signal into an electrical signal.

11. The apparatus of claim 2, wherein said plurality of radio components further comprises one or more transmitters and one or more receivers.

12. The apparatus of claim 2, wherein said plurality of radio components further comprises one or more transmitters, one or more receivers, one or more quartz crystals, one or more amplifiers, a means for converting an electrical signal into a radio signal, and a means for converting a radio signal into an electrical signal.

13. The apparatus of claim 11, wherein said one or more transmitters and said one or more receivers respectively broadcast and receive radio signals having a frequency range of about 27 MHz.

14. The apparatus of claim 11, wherein said one or more transmitters and said one or more receivers respectively broadcast and receive radio signals having a frequency range of greater than about 43 MHz and less than about 50 MHz.

15. The apparatus of claim 11, wherein said one or more transmitters and said one or more receivers respectively broadcast and receive radio signals having a frequency range of greater than about 900 MHz and less than about 928 MHz.

16. The apparatus of claim 11, wherein said one or more transmitters and said one or more receivers respectively broadcast and receive radio signals having a frequency range of about 2.4 GHz.

17. The apparatus of claim 11, wherein said one or more transmitters and said one or more receivers respectively broadcast and receive radio signals having a frequency range of about 5.8 GHz.

18. The apparatus of claim 11, wherein said one or more transmitters and said one or more receivers respectively broadcast and receive radio signals having a frequency range of greater than about 5.8 GHz.

19. The apparatus of claim 12, wherein said means for converting an electrical signal into a radio signal converts said electrical signal into an analog radio signal.

20. The apparatus of claim 12, wherein said means for converting an electrical signal into a radio signal converts said electrical signal into a digital radio signal.

21. The apparatus of claim 12, wherein said means for converting a radio signal into an electrical signal converts an analog radio signal into said electrical signal.

22. The apparatus of claim 12, wherein said means for converting a radio signal into an electrical signal converts a digital radio signal into said electrical signal.
